(19) United States
(12) Patent Application Publication
(10) Pub. No.: US 2011/0194606 A1
(43) Pub. Date: Aug. 11, 2011

(54) MEMORY MANAGEMENT METHOD AND RELATED MEMORY APPARATUS

(76) Inventors: Cheng-Yu Hsieh, Tainan County (TW); Chien-Chang Lin, Tainan County (TW)

(21) Appl. No.: 12/703,169

(22) Filed: Feb. 9, 2010

(51) Int. Cl. H04N 7/26

(52) U.S. Cl. 375/240.16; 375/240.01; 375/E07.123

(57) ABSTRACT

A memory management method includes fetching data corresponding to a plurality of image blocks, including at least two image blocks with different block sizes; and utilizing a memory device having a plurality of memory banks for storing the data corresponding to the plurality of image blocks. The memory management method and a related memory apparatus can make the memory device buffer motion blocks of variable sizes in an efficient way.

### BACKGROUND OF THE INVENTION

1. Field of the Invention

The present invention relates to memory management, and more particularly, to a memory management method and a related memory apparatus for efficiently allocating a buffer memory for motion blocks of video compression.

2. Description of the Prior Art

Motion compensation is an essential technique utilized in video compression/decompression, wherein variable block-size motion compensation is one of the most popular techniques in modern video compression standards such as H.264 or MPEG-4, which utilizes motion blocks of variable sizes (namely different sizes) for recording corresponding motion vectors. In the operation of reconstructing a compressed video file, data corresponding to motion blocks has to be loaded for processing. However, as the rate at which the data corresponding to motion blocks is derived from a data source (e.g. DRAM) is different from the rate at which the data corresponding to motion blocks is processed, the conventional art fetches in advance data corresponding to several motion blocks into a buffer memory for performing a following video processing operation (e.g. a filtering operation).

In variable block-size motion compensation, the data sizes of motion blocks may be quite different. Accordingly, the width of the buffer memory is limited to the data width of the biggest motion block. Thus, some space of the buffer memory is wasted while the data of those smaller motion blocks is buffered. Please refer to FIG. 1, which illustrates the condition where the buffer memory is wasted in the conventional art. As shown in FIG. 1, three motion blocks A, B and C respectively having the size of 21×13, 9×9, and 9×13 pixels are to be buffered in buffer memories 101, 102 and 103. Each of buffer memories 101, 102 and 103 has the same size, fitting to the biggest motion block A. As shown in FIG. 1, a lot of space in the buffer memories 101, 102 and 103 is wasted. From another point of view, each of the buffer memories 101, 102 and 103 has to wait for the motion block stored therein to be processed by the following operation so that the buffer memory can be released for a next motion block (not shown). There is also a lot of time wasted in the conventional art. Thus, some shortcomings in the conventional buffer memory management/allocation process need to be overcome.

### SUMMARY OF THE INVENTION

With this in mind, it is one objective of the present invention to provide a memory management method and a related memory apparatus which can allocate a buffer memory for image blocks (especially for motion blocks of variable sizes) more efficiently, thereby reducing the wasted space. Also, the present invention can avoid the wasting of time which occurs in the conventional art.

According to one embodiment of the present invention, a memory management method is provided. The memory management method comprises: fetching data corresponding to a plurality of image blocks, including at least two image blocks with different block sizes; and utilizing a memory device having a plurality of memory banks for storing the data corresponding to the plurality of image blocks.

According to another embodiment of the present invention, a memory apparatus is provided. The memory device comprises: a memory device, a fetching unit and an allocating unit. The memory device has a plurality of memory banks. The fetching unit is utilized for fetching data corresponding to a plurality of image blocks, including at least two image blocks with different block sizes. The allocating unit is coupled to the fetching unit and the memory, and utilized for utilizing the memory to store the data corresponding to the plurality of image blocks.

Preferably, the image blocks are motion blocks, and the data corresponding to the motion blocks is fetched according to respective motion vectors to be utilized in a video processing operation.

Preferably, data corresponding to different rows of an image block of the image blocks is stored into a same row address in different memory banks of the memory banks.

Preferably, the number of the different rows is greater than the number of the different memory banks.

Preferably, data corresponding to one row of an image block of the image blocks is stored into a same row address in different memory banks of the memory banks.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing the method of memory allocation utilized in the conventional art.

FIG. 2 is a diagram showing a method of memory allocation according to one embodiment of the present invention.

FIG. 3 is a diagram showing a method of memory allocation according to another embodiment of the present invention.

FIG. 4 is a diagram showing a method of memory allocation according to still another embodiment of the present invention.

FIG. 5 is a diagram showing a method of memory allocation according to still another embodiment of the present invention.

FIG. 6 is a diagram showing the relationship between the data is fetched and the data of a motion block.

FIG. 7 is a diagram showing a memory apparatus according to one embodiment of the present invention.

### DETAILED DESCRIPTION

According to one embodiment of the present invention, a memory management method applied in a video processing operation comprises: fetching data corresponding to a plurality of image blocks (e.g. motion blocks), including at least two image blocks with different block sizes; and utilizing a memory device (e.g. buffer memory) having a plurality of memory banks for storing the data corresponding to the plurality of image blocks. The video processing operation may be executed with motion compensation. More specifically, the video processing operation may refer to a filtering operation with variable block-size motion compensation. In general, the filtering operation with variable block-size motion compensation may utilize data corresponding to a motion block including the data of the motion block and partial data of neighboring motion blocks adjacent to the motion block is fetched. Thus, in the following, the data corresponding to the motion block refers to original data of the motion block and partial data of other motion blocks, inclusively. As the data corresponding to the motion blocks is utilized in the variable block-size motion compensation, the motion blocks may have different sizes. In addition, the data corresponding to the motion blocks may be relative to respective motion vectors to be processed in the filtering operation, and depending on different video processing architecture, the fetched data may be derived from a data source (e.g. DRAM) or a cache device, both of which are possible in the inventive memory management method.

For utilizing the memory device having the plurality of memory banks for storing the data corresponding to the motion blocks, there are several different methods provided by the invention to allocate the memory device for the data, which depends on respective block widths and block heights of each motion block. The methods of allocating the memory device will be explained in the following along with several embodiments of the present invention. It should be noted that the different methods respectively utilized in the embodiments may be utilized simultaneously or separately in other embodiments of the present invention, and these alternatives all fall within the scope of the present invention.

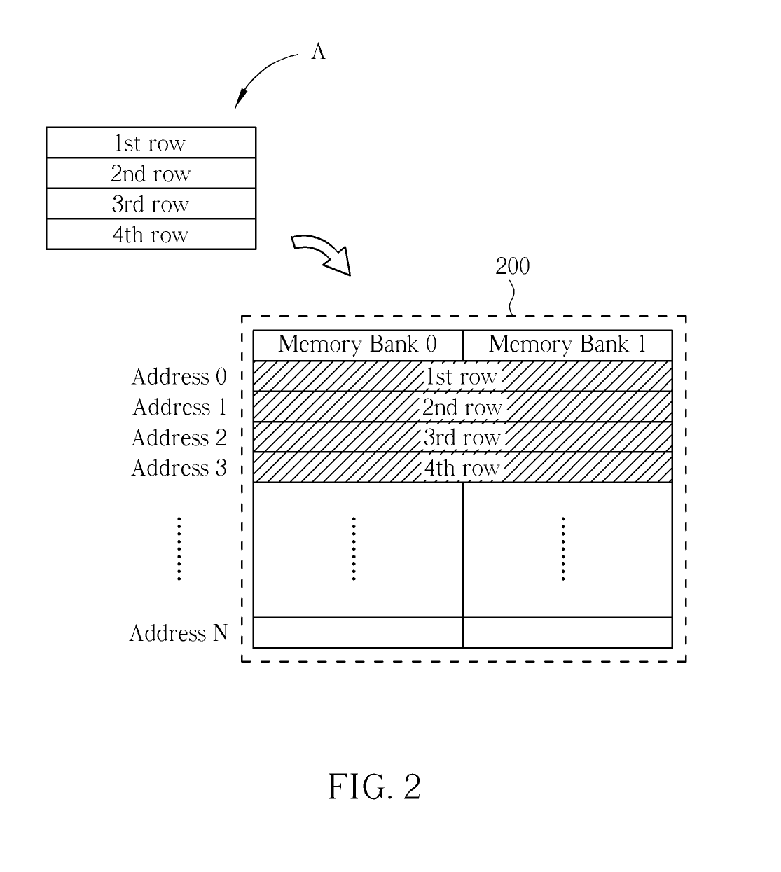

Please refer to FIG. 2, which illustrates a diagram showing how to store the motion block when a data width of each row (namely, a row of pixels) of the motion block is larger than a width of the memory bank corresponding to one row address. As shown in FIG. 2, assuming that each row of motion block A comprises 21 pixels horizontally arranged and each pixel respectively corresponds to 8 bits of data, the total data width of each row will be 168 bits. If a memory device 200 is composed of memory bank 0 and memory bank 1, one of which has a width of 80 bits while the other has a width of 88 bits, data fetched from the previous step (namely, fetching data corresponding to a plurality of image blocks) corresponding to one row is stored into a same row address in different memory banks of the memory banks. For example, the data corresponding to the 1^{st} row of motion block A is stored into the same address 0 in memory bank 0 and memory bank 1 of the memory device 200, the data corresponding to the 2^{nd} row of motion block A is stored into the same address 1 in memory bank 0 and memory bank 1 of the memory device 200, and so on. Thus, the data corresponding to each row is exactly stored in one row address of memory banks 0 and 1. In this case, no space of memory device 200 will be wasted when the data corresponding to each row of the motion block A is stored.

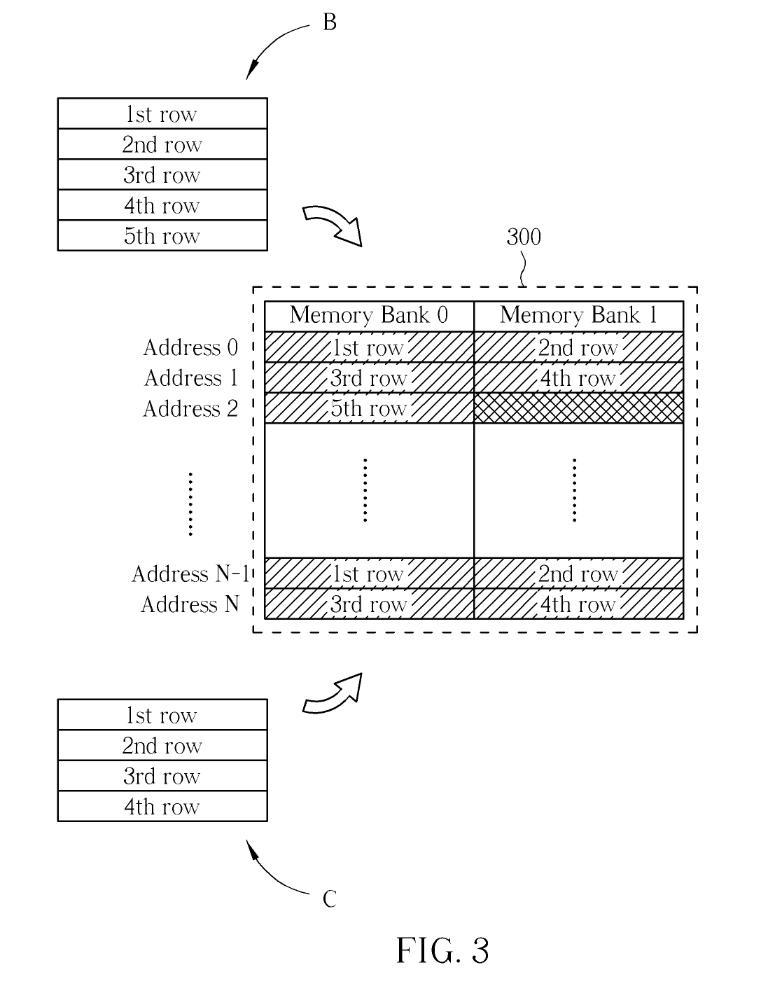

Please refer to FIG. 3, which illustrates a diagram showing how to store the motion block when a data width of each row is close to a width of the memory bank corresponding to one row address. As shown in FIG. 3, assuming that each row of motion block B comprises 11 pixels horizontally arranged and each pixel respectively corresponds to 8 bits data, the total data width of each row will be 88 bits. If a memory device 300 is composed of memory bank 0 and memory bank 1, one of which has a width of 80 bits while the other has a width of 88 bits, data fetched from the previous step corresponding to different rows of the motion block B is stored into a same row address in different memory banks of the memory banks. For example, the data corresponding to the 1^{st} row of motion block B is stored into the address 0 in memory bank 0 and the data corresponding to the 2^{nd} row of motion block B is stored into the address 0 in memory bank 1, the data corresponding to the 3^{rd} row of motion block B is stored into the address 1 in memory bank 0 while the data corresponding to the 4^{th} row of motion block B is stored into the address 1 in memory bank 1 and so on, wherein the address 2 in the memory bank 2 is left reserved or for data of row(s) of other blocks. In another case shown in FIG. 3, the data corresponding to each row of the motion block C is respectively and symmetrically stored in memory banks 0 and 1, where no memory space is left either in memory bank 0 or in memory bank 1.

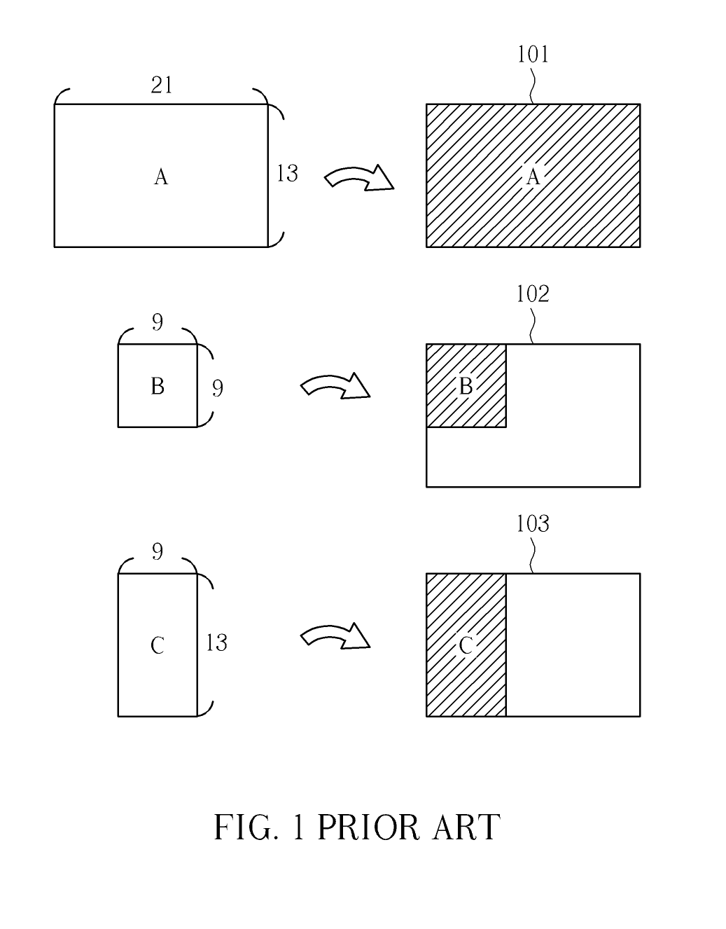

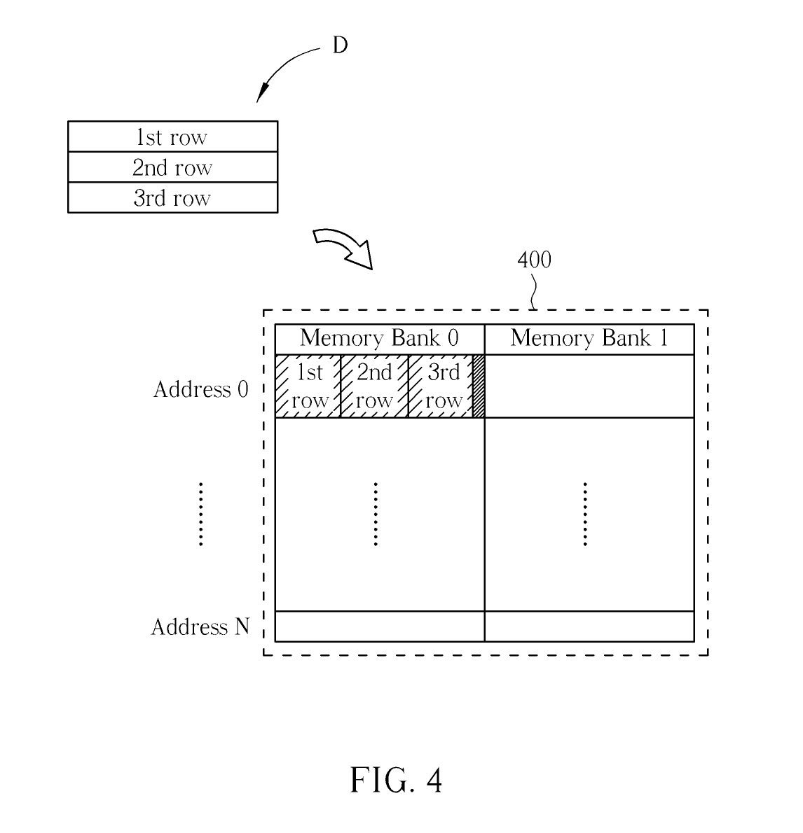

Please refer to FIG. 4, which illustrates a diagram showing how to store the motion block when a data width of each row is smaller than a width of the memory bank corresponding to one row address. As shown in FIG. 4, assuming that each row of motion block D comprises 3 pixels horizontally arranged and each pixel respectively corresponds to 8 bits of data, the total data width of each row is 24 bits. If a memory device 400 is composed of memory bank 0 and memory bank 1, one of which has a width of 80 bits while the other has a width of 88 bits, data fetched from the previous step corresponding to different rows of the motion block D is stored into a same row address in one memory bank. For example, the data corresponding to the 1^{st} row, 2^{nd} row, and 3^{rd} row of motion block D is all stored into the address 0 in memory bank 0 where some space (i.e., 8 bit) remains in the address 0 in the memory bank 0. If the data corresponding to the 1^{st} row, 2^{nd} row, and 3^{rd} row of motion block D is all stored into the address 0 in memory bank 1, there will be memory space of 16 bits remaining in the address 0 in the memory bank 1. Thus, if the methods of allocating the memory device respectively shown in FIG. 2, FIG. 3 and FIG. 4 are incorporated for buffering motion blocks of variable sizes, the usage of the buffer memory will be more efficient than the conventional art, and less space of buffer memory will be wasted compared to the conventional buffer memory allocation as shown in FIG. 1.

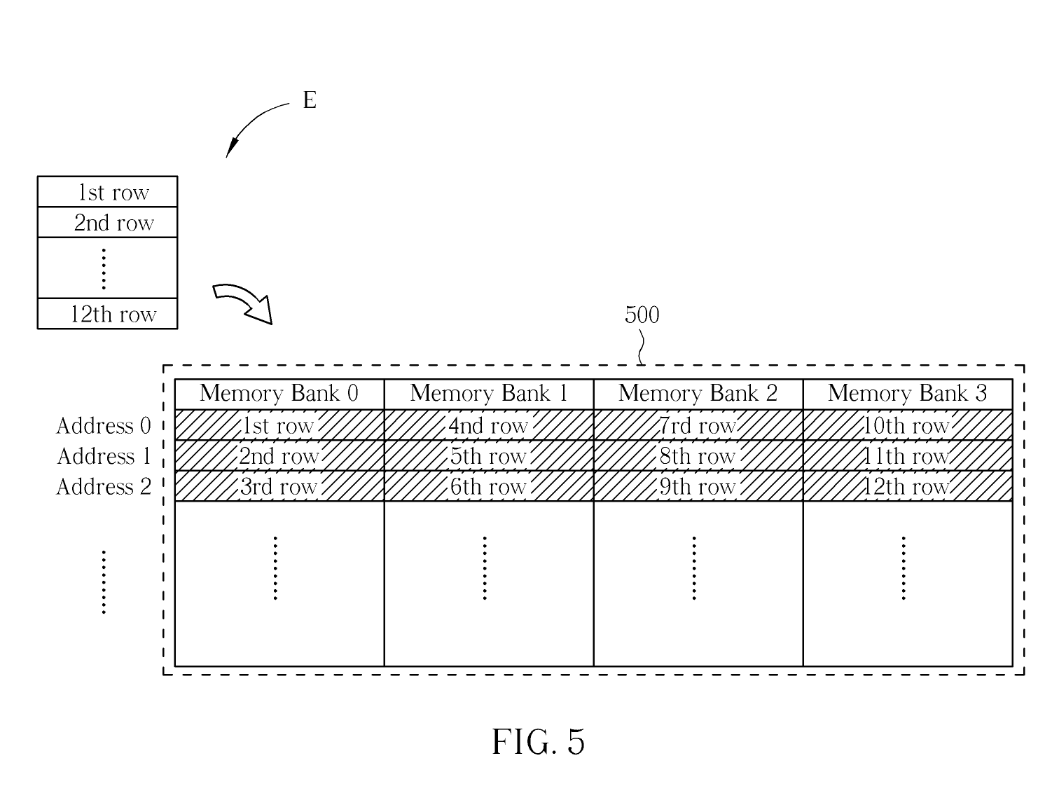

Please refer to FIG. 5, which illustrates a diagram showing how to store the motion block in a memory device having more than two memory banks and with a different arrangement than the above-mentioned case. As shown in FIG. 5, assuming that each row of motion block E comprises 11 pixels horizontally arranged and each pixel respectively corresponds to 8 bits of data, the total data width of each row is 88 bits. If a memory device 500 is composed of memory bank 0, memory bank 1, memory bank 2 and memory bank 3, each of which has a width of 88 bits, data fetched from the previous step corresponding to different rows of the motion block E is stored into a same row address in different memory banks. For example, the data corresponding to the 1^{st}, 4^{th}, 7^{th}, 10^{th} rows of motion block E is stored into the address 0 in memory banks 0, 1, 2 and 3, and so on. In this case, it is shown that the allocation of storing the data corresponding to each row and the number of memory banks in a memory device is not limited. Also, the number of bits of each memory bank and the data corresponding to each row is also not limited, and may be different according to different implementations. The foregoing descriptions are merely for the purpose of illustration rather than a limitation.

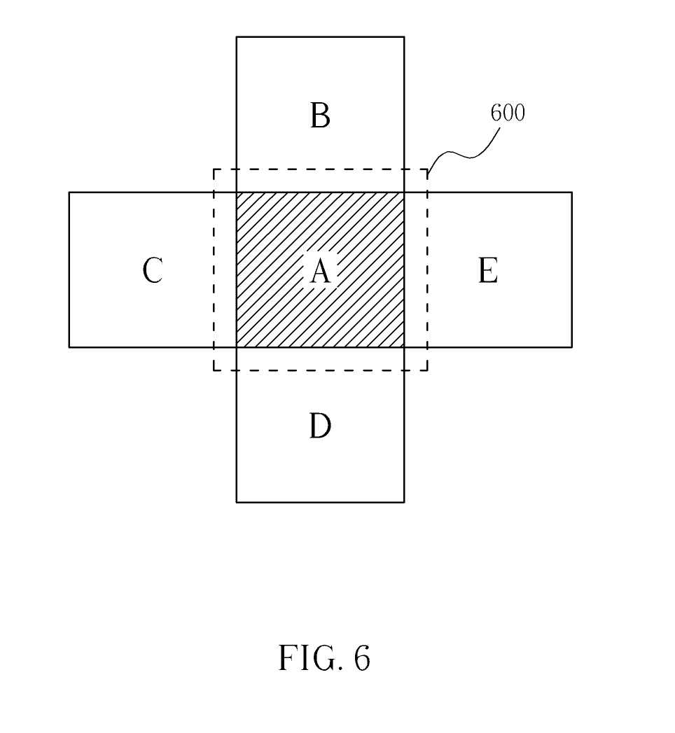

Furthermore, as the filtering operation with variable block-size motion compensation may utilize data corresponding to a motion block including the data of the motion block and partial data of neighboring motion blocks adjacent to the motion block, the step of fetching the corresponding motion blocks may repeatedly request the same data, as shown in FIG. 6. FIG. 6 shows 5 motion blocks. To fetch the data corresponding to the motion block A means fetching the data included in the dashed region 600. Partial data of motion blocks B, C, D and E is also fetched during the step of fetching the data corresponding to the motion block A. Thus, for preventing the repeated requests for the same data from the data source, a cache device is utilized in the present invention. Accordingly, the step of fetching the data corresponding to the motion block further includes checking whether at least a portion of the data corresponding to the motion block has already been cached in the cache device before fetching the data corresponding to the motion block; when the portion of the data corresponding to the motion block has already been cached in the cache device, the process includes fetching the portion of data corresponding to the motion block from the cache device, fetching a remaining portion of data corresponding to the motion block from the data source, and caching the fetched remaining portion of data corresponding to the image block in the cache device; and when none of the data corresponding to the motion block is cached in the cache device, the process includes fetching the data corresponding to the motion block from the data source, and caching the fetched data corresponding to the motion block in the cache device.

The frequency regarding fetching the data corresponding to different motion blocks has an influence on the system loading of the video processing (especially the loading of the data source). Therefore, a time interval between successively fetching data corresponding to two motion blocks of the motion blocks is adjustable. More specifically, the present invention dynamically adjusts the time interval according to a latency of the data source. If the latency of the data source is high, it is necessary to fetch the data corresponding to the motion blocks more frequently; otherwise, the rate at which the data corresponding to the motion blocks is fetched may lag behind the rate at which the data is processed. Thus, in a high latency situation, the time interval between successively fetching the data corresponding to two motion blocks of the motion blocks is determined to be shorter and in a low latency situation, the time interval is determined to be longer. This may be implemented with a latency signal sent by a memory interface for interfacing with the data of the data source.

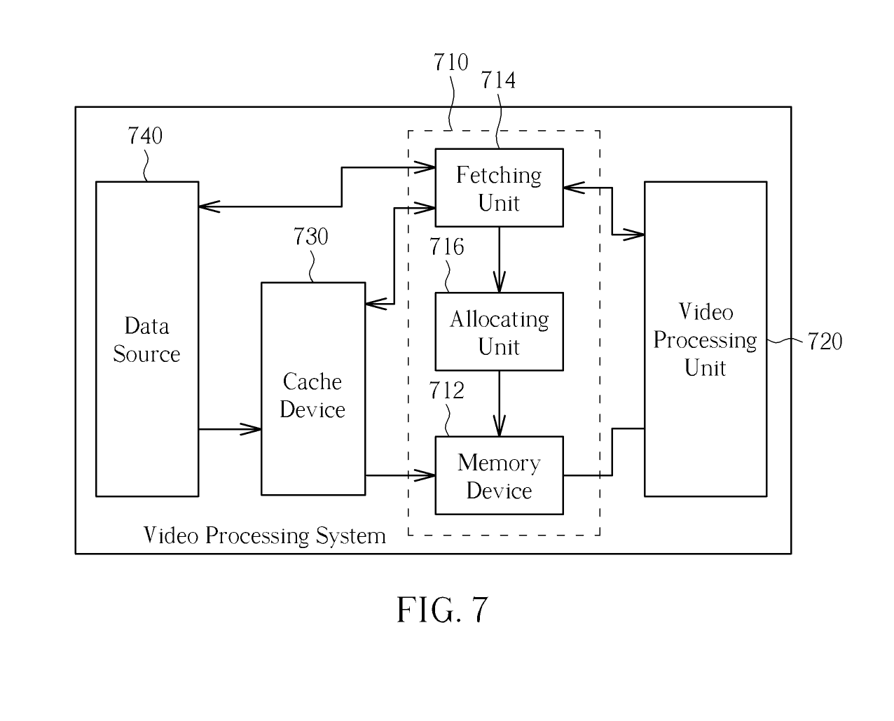

Based on the memory management method set forth above, the present invention provides a memory apparatus designed accordingly. Please refer to FIG. 7, which shows an inventive memory apparatus applied in a video processing system according to one embodiment of the present invention. As shown in FIG. 7, a video processing system 700 includes (but is not limited to) a memory apparatus 710, a video processing unit 720, a cache device 730, and a data source 740. The video processing system may be a part of a motion compensation system in video decompression architecture for processing H.263, H.264, MPEG-4 AVC or VC-1 multimedia files. In particular, the video processing unit 720 may perform filtering operations with variable block-size motion compensation according to data corresponding motion blocks in the data source 740 (e.g. DRAM). In other words, data of motion blocks of variable sizes may be stored in the data source 740 and are loaded for the video processing unit 720, wherein before the data corresponding to motion blocks is utilized by the video processing unit 720, the data will be buffered in the inventive memory apparatus 710 in advance as there is generally a difference between the rate at which the data is received from the data source 740 and the rate at which the data is actually processed by the video processing unit 720.

The memory apparatus 710 for buffering the data corresponding to motion blocks includes a memory device 712, a fetching unit 714 and an allocating unit 716. The memory device 712 has a plurality of memory banks and is utilized for storing the data corresponding to the motion blocks of different sizes. The fetching unit 714 is utilized for fetching the data corresponding to the motion blocks. In particular, the fetching unit 714 may send addresses and requests to the data source 740 or the cache device 730 for obtaining the data corresponding to the motion blocks according to respective motion vectors corresponding to the motion blocks. The allocating unit 716 is coupled to the fetching unit 714 and the memory device 712, and utilizes (namely, allocates) the memory device 712 for the data corresponding to the motion blocks. The methods utilized by the allocating unit 716 to allocate the memory device 712 for motion blocks of variable sizes has already been illustrated in the above, so detailed descriptions are omitted here for the sake of brevity. Furthermore, the cache device 730 (which may be included in a memory interface (not shown)) is utilized for caching the data of motion blocks from the data source 740 to the memory device 712. In fact, the data corresponding to the motion blocks utilized by the video processing unit 720 are usually more than the original data of the motion block, which is one technique commonly employed in the motion compensation process. In particular, in such a technique, the video processing unit 720 actually utilizes the data including data of the motion block and partial data of neighboring motion blocks adjacent to the motion block being fetched. Accordingly, some of the data in the data source 740 may be repeatedly requested since data of the motion block is always loaded along with additional data corresponding to other blocks. The cache device 730 is designed for reducing repeated access to the data source 740.

Before the fetching unit 714 fetches the data corresponding to the motion block from the data source 740 or the cache device 730, the fetching unit 714 checks whether at least a portion of the data corresponding to the motion block to be fetched has already been cached in the cache device 730. Accordingly, when the portion of the data corresponding to the motion block has already been cached in the cache device 730, the fetching unit 714 fetches the portion of data corresponding to the motion block from the cache device 730, and then fetches a remaining portion of data corresponding to the motion block from the data source 740. Finally, the fetched remaining portion of data corresponding to the motion block is also cached in the cache device 730. When the fetching unit 714 finds out none of the data corresponding to the motion block are cached in the cache device 730, the fetching unit 714 fetches the data corresponding to the motion block from the data source 740, and then the fetched data corresponding to the motion block is also cached in the cache device 730.

In addition, the frequency of the fetching unit 714 sending requests and addresses for fetching data has an influence on the loading of the video processing system 700 (especially the loading the data source 740). Therefore, a time interval between successively fetching data corresponding to two motion blocks of the motion blocks is adjustable. More specifically, the fetching unit 714 dynamically adjusts the time interval according to a latency of a data source 740. In particular, the fetching unit 714 determines the time interval according to the latency of the data source 740. If the latency of the data source 740 is high, it is necessary to fetch the data more frequently; otherwise, the rate at which the data corresponding to the motion blocks is fetched may lag behind the rate at which the data corresponding to the motion blocks processed is processed. Thus, in a high latency situation, the time interval between successively fetching the data corresponding to two motion blocks of the motion blocks is determined to be shorter and in a low latency situation, the time interval is determined to be longer. This may be implemented with a latency signal sent by a memory interface (not shown) for interfacing with the data of the data source 740.

In conclusion, the present invention provides a memory management method and a related memory apparatus that can allocate the buffer memory more efficiently than the conventional art. Also, since the buffer memory in the present invention can be regarded as a memory pool due to the inventive memory management method, the time wasted in the conventional art will be saved. In particular, since the inventive memory management method can efficiently find out an available space for a motion block, it is unnecessary in the present invention that the buffer memory has to wait for a motion block to be released before a next motion block can arrive. Particularly for video compression such as H.264 utilizing the variable block-size compensation technique, the present invention can significantly improve the performance of the buffer memory.

Those skilled in the art will readily observe that numerous modifications and alterations of the device and method may be made while retaining the teachings of the invention.

What is claimed is:

1. A memory management method, comprising:
fetching data corresponding to a plurality of image blocks, the plurality of image blocks including at least two image blocks with different block sizes; and
utilizing a memory device having a plurality of memory banks for storing the data corresponding to the plurality of image blocks.

2. The memory management method of claim 1, wherein the image blocks are motion blocks, and the step of fetching data corresponding to the image blocks comprises:
fetching the data corresponding to the motion blocks according to respective motion vectors to be utilized in a video processing operation.

3. The memory management method of claim 1, wherein the step of storing the data corresponding to the image blocks comprises:
storing data corresponding to different rows of an image block of the image blocks into a same row address in different memory banks of the memory banks.

4. The memory management method of claim 3, wherein a number of the different rows is greater than a number of the different memory banks.

5. The memory management method of claim 1, wherein the step of storing the data corresponding to the image blocks comprises:
storing data corresponding to one row of an image block of the image blocks into a same row address in different memory banks of the memory banks.

6. The memory management method of claim 1, wherein data corresponding to each image block of the image blocks includes data of the image block and partial data of at least one neighboring image block of the image block.

7. The memory management method of claim 6, wherein the step of fetching the data corresponding to the image blocks comprises:
for each image block of the image blocks:
before fetching the data corresponding to the image block, checking whether at least a portion of the data corresponding to the image block is cached in a cache device;
when the portion of the data corresponding to the image block is cached in the cache device, fetching the portion of data corresponding to the image block from the cache device, fetching a remaining portion of data corresponding to the image block from a data source, and caching the fetched remaining portion of data corresponding to the image block in the cache device; and
when none of the data corresponding to the image block is cached in the cache device, fetching the data corresponding to the image block from the data source, and caching the fetched data corresponding to the image block in the cache device.

8. The memory management method of claim 1, wherein a time interval between successively fetching data corresponding to two image blocks of the image blocks is adjustable.

9. The memory management method of claim 1, wherein the time interval is dynamically adjusted according to a latency of a data source which provides data of the image blocks.

10. A memory apparatus, comprising:
a memory device having a plurality of memory banks;
a fetching unit, for fetching data corresponding to a plurality of image blocks, including at least two image blocks with different block sizes; and
an allocating unit, coupled to the fetching unit and the memory, for utilizing the memory to store the data corresponding to the plurality of image blocks.

11. The memory apparatus of claim 10, wherein the image blocks are motion blocks, and the fetching unit fetches the data corresponding to the motion blocks according to respective motion vectors to be utilized in a video processing operation.

12. The memory apparatus of claim 10, wherein the allocating unit stores data corresponding to different rows of an image block of the image blocks into a same row address in different memory banks of the memory banks.

13. The memory apparatus of claim 12, wherein a number of the different rows is greater than a number of the different memory banks.

14. The memory apparatus of claim 10, wherein the allocating unit stores data corresponding to one row of an image block of the image blocks into a same row address in different memory banks of the memory banks.

15. The memory apparatus of claim 10, wherein data corresponding to each image block of the image blocks includes data of the image block and partial data of at least one neighboring image block of the image block.

16. The memory apparatus of claim 15, wherein for each image block of the image blocks:
before fetching the data corresponding to the image block, the fetching unit checks whether at least a portion of the data corresponding to the image block is cached in a cache device;
when the portion of the data corresponding to the image block is cached in the cache device, the fetching unit fetches the portion of data corresponding to the image block from the cache device, fetches a remaining portion of data corresponding to the image block from a data source, and the fetched remaining portion of data corresponding to the image block is cached in the cache device; and
when none of the data corresponding to the image block is cached in the cache device, the fetching unit fetches the data corresponding to the image block from the data source, and the fetched data corresponding to the image block is cached in the cache device.

17. The memory apparatus of claim 10, wherein a time interval between successively fetching data corresponding to two image blocks of the image blocks is adjustable.

18. The memory apparatus of claim 10, wherein the fetching unit dynamically adjusts the time interval according to a latency of a data source which provides data of the image blocks.
